(19) United States
(12) Patent Application Publication
(10) Pub. No.: US 2007/0049727 A1
(43) Pub. Date: Mar. 1, 2007

(54) Low sulfur tall oil fatty acid

(76) Inventors: Charles M. Pollock, Savannah, GA (US); H. Jerrold Miller, Savannah, GA (US); M. David Peterson, Jacksonville, FL (US)

Correspondence Address: INTERNATIONAL PAPER COMPANY, 6285 TRI-RIDGE BOULEVARD, LOVELAND, OH, 45140, US

(21) Appl. No.: 11/505,213

(22) Filed: Aug. 15, 2006

Related U.S. Application Data
(60) Provisional application No. 60/708,425, filed on Aug. 15, 2005.

(51) Int. Cl. C11B 13/00

(52) U.S. Cl. 530/205

(57) ABSTRACT

The invention relates to tall oil fatty acid compositions having low sulfur content, as well as methods of using and making the same.

The present invention is related to, and claims the benefit of 119(e) priority to U.S. provisional patent application Ser. No. 60/708,425; entitled “Low Sulfur Tall Oil Fatty Acid”, which was filed on Aug. 15, 2005, and is hereby incorporated, in its entirety, herein by reference.

### FIELD OF THE INVENTION

The invention relates to tall oil fatty acid compositions having low sulfur content, as well as methods of using and making the same.

### BACKGROUND OF THE INVENTION

Economic and environmental considerations are forcing great market demand for renewable resources of raw materials, such as those utilized in the transportation industry. Examples include the fuel and fuel package market. As standards increasingly require sulfur content within fuels to be reduced, fuel packages and fuel additives must also coincide with such regulations. Therefore, there is a great need for fuels, fuel packages, and fuel additives to have low sulfur content therein.

Tall oil products such as tall oil fatty acid (TOFA), derivatives thereof such as esters and alcohols, as well as fatty acid compositions containing the same is one such source of such fuels and/or fuel additives. TOFA and/or its derivatives, for example, are considered very valuable as a fuel and/or fuel additive due to their low temperature stability properties, especially as compared to vegetable and/or non-woody-based oil and/or fatty acid products. However, sulfur species are introduced into tall oil products during the Kraft process, which includes the addition of sodium sulfide and sodium hydroxide to wood chips for digestion, and then the neutralization/acidification of the basic mixture with sulfuric acid. Both of these processes can generate sulfur species, organic and/or inorganic alike, which are carried along with the black liquor soap, and then into the crude tall oil (CTO). Further refinement through fractional distillation of the CTO generally concentrates the sulfur species into specific product streams (pitch, rosin, and heads); however it does not eliminate the sulfur species from TOFA.

Until now, tall oil fatty acid was seen in the art as having an undesirable level of sulfur content therein to be efficiently utilized in, or as, environmentally-friendly fuels, fuel packages, and fuel additives, especially since the inception of new laws restricting environmentally unfriendly emissions from the automobile industry. The drive for more environmentally friendly automobiles which contain modern technologies will require low sulfur fuel, fuel additives and fuel packages. Otherwise, the presence of such traditional levels of sulfur may “poison” such technology, substantially reducing the lifespan of this technology; and thus, being economically inefficient.

In addition, high sulfur content in tall oil products, such as TOFA, prohibits the downstream conversion of such products into useful value-added chemistries. One example of such a conversion is the hydrogenation of tall oil products into alcohols. Another example is the hydrogenation of dimer acids as well as Monomer (CAS Registry Number 68955-98-6) Conventional tall oil products contain so much sulfur that hydrogenation catalysts are contaminated by the these sulfur containing species, thus “killing” or “poisoning” the catalyst and making the conversion of such conventional tall oil products very economically inefficient and undesirable. Thus, there exists a need to create tall oil products from renewable resources in a manner so as to ensure low sulfur content therein and maintain low temperature stability thereof.

### BRIEF DESCRIPTION OF THE DRAWINGS

FIG. 1: shows the results when distilled or undistilled TOFA is subjected to various amounts (1-5%) silica adsorbent to make one embodiment of the composition according to the present invention.

FIG. 2 shows the results when distilled or undistilled TOFA is subjected to various amounts (1-5%) clay adsorbent.

### DETAILED DESCRIPTION OF THE INVENTION

This application is related to the fields of chemistry and chemical engineering which is described, for example, in Kirk-Othmer “Encyclopedia of Chemical Technology”, fourth edition (1996), John Wiley & Sons, which is hereby incorporated, in its entirety, herein by reference.

The inventors have surprisingly found a composition that is relatively low cost and environmental friendly for use as or in a fuel, fuel package, and/or fuel additive. This composition is a renewable resource and is especially suitable for use in the diesel or gasoline markets. The composition comprises biomass and/or byproducts thereof. Thus, the composition is a renewable resource. Examples of a biomass product may be the byproducts of paper making from trees such as tall oil products. Accordingly, biomass products, such as those similar to black liquor solids, soaps, skimmings, as well as tall oil products such as pitch and/or distillate products thereof are examples of such biomass products. Further, such biomass products of the present invention are predominantly environment friendly, especially compared to those traditional tall oil products. Finally, the composition of the present invention has low sulfur content and preferably exhibits low temperature stability.

The present invention provides a method for reducing the sulfur content of a fatty acid-containing composition (FAC), and also provides fatty acid-containing compositions that demonstrate low sulfur content. Further, the present invention relates to methods of making and using such fatty acid-containing compositions.

As used herein, the terms “fatty acid” and “fatty acids”, whether in reference to linear, branched or cyclic fatty acids, are used interchangeably, and both terms refer to one or more compounds of the formula R¹—COOH wherein R¹ is a hydrocarbon having at least 4 carbon atoms that is optionally substituted with one or more hydroxyl groups, or derivatives thereof. Further, the —COOH group is an acid group. The fatty acid may contain any number of hydroxyl groups and may vary widely based upon the number of carbon atoms present in the fatty acid. For example, the fatty acid may contain at least 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30 hydroxyl groups. As used herein, the term hydrocarbon refers to a chemical group formed entirely of carbon and hydrogen. The term “optionally substituted with one or more hydroxyl groups” refers to the replacement of a hydrogen atom of the hydrocarbon with a hydroxyl (—OH) group. The R¹ group typically has no more than 99 carbons, so that the fatty acid has a total of no more than 100 carbons. In various embodiments of the invention, the R¹ group has at least 5, 6, 7, 8, 9, 10, 11, 12, 13, 14, 15, 16, 17, 18, 19, 20, 21, 22, 23, 24, 25, 26, 27, 28, 29, or 30 carbons. The present invention provides embodiments wherein the maximum number of carbons in the R¹ group is, in various embodiments, 99, 90, 80, 70, 60, 50, 40, 39, 38, 37, 36, 35, 34, 33, 32, 31, or 30 carbons. In a preferred embodiment, R¹ contains 4-29 carbons, more preferably 7-25 carbons, and most preferably from 15 to 23 carbon atoms.

The fatty acids may contain, n, acid functional groups, where n may be from 1 to 10, preferably from 1 to 6 acid functional groups, more preferably from 1 to 3 acid functional groups.

The “fatty acid” or “fatty acids” of the present invention may be a single fatty acid structure or may be a mixture of different fatty acid structures. Regardless of the purity or composition, for convenience in describing the present invention, the fatty acid that is being modified to provide reduced sulfur content will be referred to herein as the fatty acid-containing composition, or FAC for short. For instance, the FAC may be pure stearic acid, oleic acid, and/or linoleic acid, wherein R¹ is C₁₇. As used herein “Cₙ” refers to a group having “n” number of carbons. In the case of stearic acid, R¹ has 17 carbons. As used herein, “pure” refers to a concentration of fatty acids of 99-100 weight percent of the referenced fatty acids based on the total weight of fatty acids in the mixture/composition/blend.

As referred to herein, the FAC that is modified to provide low sulfur content is, in various embodiments of the present invention, in admixture with no more than 99 wt % of non-fatty acid material, or, in various other embodiments of the invention, no more than 99, 98, 97, 96, 95, 90, 80%, or 70%, or 60%, or 50%, or 40%, or 30%, or 20%, or 10%, or 5%, or 3%, or 1%, or less than 1% such as 0.1 wt %, 0.01 wt %, 0.001 wt %, or 0.0001 wt % of non-fatty acid material, where these weight percent values are based on the entire weight of the composition.

As another example, the FAC may be a mixture of fatty acids. That is, a composition containing two or more fatty acids having non-identical R¹ groups. For instance, the FAC may contain branched and/or cyclic fatty acids. In a preferred embodiment, the FAC contains a majority, i.e., greater than 50%, of fatty acids, on a weight percent basis, based on the total weight of fatty acids in the composition. In another embodiment, the FAC contains a minority, i.e., less than 50%, of fatty acids, on a weight percent basis, based on the total weight of fatty acids in the composition

In one exemplary embodiment of the present invention, the FAC contains predominantly C₁₂₋₂₄ fatty acids (R¹=C₁₁₋₂₃), while in another embodiment the FAC contains predominantly C₁₆₋₂₀ fatty acids (R¹=C₁₅₋₁₉). In other exemplary embodiments of the present invention, the FAC contains at least 90% C₁₂₋₂₄ fatty acids (R¹=C₁₁₋₂₃), while in another embodiment the FAC contains at least 90% C₁₆₋₂₀ fatty acids (R¹=C₁₅₋₁₉).

Independent of the number of carbons in the hydrocarbon, in various embodiments of the present invention the R¹ group may be, branched, or cyclic, and independently may be saturated or unsaturated. The term unsaturated includes both monounsaturated and polyunsaturated, where polyunsaturated includes 2, 3, 4 or more sites of unsaturation. A site of unsaturation is a double bond between two adjacent carbons of R¹.

In one aspect of the invention, the R¹ groups in the FAC are primarily unsaturated, i.e., at least 50 mol % of the fatty acids in the FAC has a R¹ group that is unsaturated. In various embodiments of the present invention, at least 50%, 60%, 70%, 80%, 90% or 95% of the R¹ groups in the FAC are unsaturated. In one aspect, the fatty acids are primarily saturated, i.e., at least 50 mol % of the fatty acids does not have a double bond in the R¹ group. Thus, in various embodiments of the present invention, and for each of the above-recited percentage amounts of R¹ groups in the FAC, at least 50%, 60%, 70%, 80%, 90%, 95% or 98% of the R¹ groups are saturated, with the remainder of the R¹ groups being unsaturated.

In another aspect of the invention, the R¹ groups in the FAC are primarily cyclic and/or polycyclic, i.e., at least 50 mol % of the fatty acids in the FAC has a cyclic R¹ group. Thus, in various embodiments of the present invention, at least 50%, 60%, 70%, 80%, 90% or 95% of the R¹ groups are cyclic. In one aspect, the cyclic fatty acids are primarily saturated, i.e., at least 50 mol % of the cyclic fatty acids does not have a double bond in the R¹ group. Thus, in various embodiments of the present invention, and for each of the above-recited percentage amounts of cyclic R¹ groups in the fatty acids, at least 50%, 60%, 70%, 80%, 90%, 95% or 98% of the R¹ groups are unsaturated, with the remainder of the R¹ groups being saturated.

In another aspect of the invention, the R¹ groups in the FAC are primarily linear, i.e., at least 50 wt % of the fatty acids in the FAC has a cyclic R¹ group. Thus, in various embodiments of the present invention, at least 50 wt %, 60%, 70%, 80%, 90% 95%, 97, 98, 99, 99.9, 99.99, or 99.999 of the R¹ groups are linear. In this aspect, the amount fatty acids having linear R¹ groups may be from 50 to 99.999 wt %, preferably from 85 to 99.999 wt %, based upon the total weight of the FAC. The amount of fatty acids having linear R¹ groups may be 50, 55, 60, 65, 70, 75, 80, 85, 90, 95, 96, 97, 98, 99, 99.9, 99.99, and 99.999 wt % based upon the total weight of the FAC, including any and all ranges and subranges therein.

In addition, the amount of fatty acids having cyclic R¹ groups may be from 0.001 to 50 wt %, preferably from 0.1 to 15 wt %, based upon the total weight of the FAC. Thus, in various embodiments of the present invention, not more than 50 wt %, 40%, 30%, 20%, 15% 10%, 9, 8, 7, 6, 5, 4, 3, 2, 1, 0.1, 0.01, and 0.001 wt % of fatty acids having R¹ groups that are cyclic are present in the FAC. The amount of fatty acids having cyclic R¹ groups may be 50, 45, 40, 35, 30, 25, 20, 15, 10, 5, 4, 3, 2, 1, 0.1, 0.01, and 0.001 wt % based upon the total weight of the FAC, including any and all ranges and subranges therein.

In one aspect of the invention, the R¹ group is a hydroxyl-substituted hydrocarbon. In one aspect, the hydrocarbon is substituted with a single hydroxyl group. Suitable FAC having hydroxyl-substituted hydrocarbon R¹ groups include fatty acids derived from castor oil, e.g., ricinoleic acid and hydroxystearic acids.

According to the present invention, the fatty acid may be a branched chain fatty acid (BCFA). In one aspect of the invention, the BCFA is a saturated BCFA that may be described by the following formula, wherein each of x, y, and z is independently selected from 0-26: CH₃—(CH₂)ₓ—CH[(CH₂)yCH₃]—(CH₂)_{z}—COOH wherein x+y+z=6-26. In various embodiments of the invention, x+y+z=6, or 7, or 8, or 9, or 10, or 11, or 12, or 13, or 14, or 15, or 16, or 17, or 18 as the lower limit on the number of carbon atoms represented by the sum of x, y and z. Independently, for each of these embodiments, the upper limit of the sum x, y and z is 26, or 25, or 24, or 23, or 22, or 21, or 20, or 19. In various embodiments of the invention, y+z=6, or 7, or 8, or 9, or 10, or 11, or 12, or 13, or 14, or 15, or 16, or 17, or 18 as the lower limit on the number of carbon atoms represented by the sum of y and z. Independently, for each of these embodiments, the upper limit of the sum y and z is 26, or 25, or 24, or 23, or 22, or 21, or 20, or 19. In various embodiments of the invention, x+y=6, or 7, or 8, or 9, or 10, or 11, or 12, or 13, or 14, or 15, or 16, or 17, or 18 as the lower limit on the number of carbon atoms represented by the sum of x and y. Independently, for each of these embodiments, the upper limit of the sum x and y is 26, or 25, or 24, or 23, or 22, or 21, or 20, or 19.

While the above example is that of a saturated BCFA, the BCFA may be either saturated or unsaturated as discussed above generally with regard to the FAC.

Examples which come within this group and are offered commercial are: 2-methylpropanoic (isobutyric)—(Hoechst, Eastman); 2-methylbutanoic (isopentanoic)—(Union Carbide); 3-methylbutanoic (isovaleric)—(Hoechst); 2,2-dimethylpropanoic (neopentanoic)—(Exxon); isooctanoic—(Hoechst); 2-ethylhexanoic—(Eastman, Union Carbide); and 2,2-dimethyloctanoic (neodecanoic)—(Exxon).

The BCFA of the present invention contains at least one branch point on the carbon chain of the fatty acid. However, the BCFA may contain more than one branch point and still be a BCFA according to the present invention. For instance, a BCFA may have two or more methyl substituents, or two or more ethyl substituents, or one methyl and one ethyl substituent, etc. In one aspect of the invention, the BCFA is a mono-unsaturated branched chain fatty acid. In another aspect of the invention, the BCFA is a poly-unsaturated branched chain fatty acid.

Cyclic fatty acids (CFA) include, without limitation, rosin and/or resin acids, where such acids include, for example, abietic acid, levopimaric acid, neoabietic acid, palustric acid, dehydroabietic acid, isopimaric acid, sandaracopimaric acid, pimaric acid, communic acid, and secodehydroabietic acid. Other sources of cyclic fatty acids include Tall Oil, Tall Oil Heads, Distilled Tall Oil, Pitch, and Rosin, where each of these materials is a product of the distillation of naval stores. See, e.g., Naval Stores—Production, Chemistry and Utilization, D. F. Zinkel and J. Russel (eds.), Pulp. Chem. Assoc. Inc., 1989. Further examples of CFA and derivatives thereof include those derived from or sourced from wood rosin and/or gum rosin, including, but not limited to, esters thereof, for example. In one embodiment of the present invention, the CFA are and/or are derived from resin and/or rosin acids. Examples of rosin acids may include those mentioned in U.S. Pat. Nos. 6,875,842; 6,846,941; 6,344,573; 6,414,111; 4,519,952; and 6,623,554, which are hereby incorporated, in their entirety, herein by reference.

CFA also includes the internal cyclization product of fatty acid. When unsaturated fatty acid is heated, particularly in the presence of clay catalysts as occurs during formation of polymerized fatty acid, the unsaturated fatty acid may undergo an internal cyclization reaction and thereby form a cyclic fatty acid. Such cyclic fatty acids are CFA's according to the present invention. See, e.g., Naval Stores—Production, Chemistry and Utilization, D. F. Zinkel and J. Russel (eds.), Pulp. Chem. Assoc. Inc., 1989.

BCFA and CFA can be obtained from many sources. For instance, suppliers of fine and bulk chemicals may sell BCFA and CFA. See, e.g., Acros Organics (Pittsburgh Pa.), Aldrich Chemical (Milwaukee Wis., including Sigma Chemical and Fluka), Apin Chemicals Ltd. (Milton Park UK), Avocado Research (Lancashire U.K.), BDH Inc. (Toronto, Canada), Bionet (Cornwall, U.K.), Chemservice Inc. (West Chester Pa.), Crescent Chemical Co. (Hauppauge N.Y.), Eastman Organic Chemicals, Eastman Kodak Company (Rochester N.Y.), Fisher Scientific Co. (Pittsburgh Pa.), Fisons Chemicals (Leicestershire UK), Frontier Scientific (Logan Utah), ICN Biomedicals, Inc. (Costa Mesa Calif.), Key Organics (Cornwall U.K.), Lancaster Synthesis (Windham N.H.), Maybridge Chemical Co. Ltd. (Cornwall U.K.), Parish Chemical Co. (Orem Utah), Pfaltz & Bauer, Inc. (Waterbury Conn.), Polyorganix (Houston Tex.), Pierce Chemical Co. (Rockford Ill.), Riedel de Haen AG (Hannover, Germany), Spectrum Quality Product, Inc. (New Brunswick, N.J.), TCI America (Portland Oreg.), Trans World Chemicals, Inc. (Rockville Md.), and Wako Chemicals USA, Inc. (Richmond Va.), to name a few.

The above-listed chemical suppliers may also sell the corresponding alcohols, i.e., compounds of the formula R¹—CH₂—OH, which can be oxidized to the desired BCFA or CFA by techniques well known in the art (see, e.g., Fuhrhop, J. and Penzlin G. “Organic Synthesis: Concepts, Methods, Starting Materials”, Second, Revised and Enlarged Edition (1994) John Wiley & Sons ISBN: 3-527-29074-5; Hoffman, R. V. “Organic Chemistry, An Intermediate Text” (1996) Oxford University Press, ISBN 0-19-509618-5; Larock, R. C. “Comprehensive Organic Transformations: A Guide to Functional Group Preparations” 2nd Edition (1999) Wiley-VCH, ISBN: 0-471-19031-4; March, J. “Advanced Organic Chemistry: Reactions, Mechanisms, and Structure” 4th Edition (1992) John Wiley & Sons, ISBN: 0-471-60180-2; Patai, S. “Patai's 1992 Guide to the Chemistry of Functional Groups” (1992) Interscience ISBN: 0-471-93022-9; Solomons, T. W. G. “Organic Chemistry” 7th Edition (2000) John Wiley & Sons, ISBN: 0-471-19095-0; Stowell, J. C., “Intermediate Organic Chemistry” 2nd Edition (1993) Wiley-Interscience, ISBN: 0-471-57456-2; “Industrial Organic Chemicals: Starting Materials and Intermediates: An Ullmann's Encyclopedia” (1999) John Wiley & Sons, ISBN: 3-527-29645-X, in 8 volumes; “Organic Reactions” (1942-2000) John Wiley & Sons, in over 55 volumes; and “Chemistry of Functional Groups” John Wiley & Sons, in 73 volumes.)

A preferred BCFA and CFA is a by-product of dimer acid production. The dimerization of fatty acids, and particularly TOFA, to produce dimer acid, is well known in the art. See, e.g., Naval Stores—Production, Chemistry and Utilization, D. F. Zinkel and J. Russel (eds.), Pulp. Chem. Assoc. Inc., 1989. At the end of the dimerization process, during purification of the dimer acid, a mono-carboxylic acid distillation product is typically obtained, where this distillation product is commonly referred to in the art as monomer acid or simply as “monomer”. Monomer is typically a mixture of branched, aromatic, cyclic, and straight chain fatty acids, which may be saturated or unsaturated. The predominant acid in monomer is iso-oleic acid, a mixture of branched and cyclic C₁₈ mono-unsaturated fatty acids. The iso-oleic acid may be refined from monomer by low temperature solvent separation, in order to prepare a purified iso-oleic acid. Both monomer and the purified iso-oleic acid is a BCFA of the present invention, where iso-oleic acid of about 90% purity is a preferred BCFA of the invention. Noteworthy is that, as this example illustrates, BCFA need not be a pure material, but may be in admixture with other materials, even fatty acids that are not branched.

Either of monomer or the purified iso-oleic acid may be subjected to a hydrogenation process to provide the corresponding saturated BCFA, where either of these saturated BCFAs is a BCFA of the present invention. Hydrogenated iso-oleic acid is also known as iso-stearic acid.

Dimer acid is produced by many companies that generally produce products based on naval stores. Arizona Chemical (Jacksonville, Fla. USA; www.arizonachemical.com); Cognis Corp USA (division of Cognis BV; Cincinnati, Ohio USA; www.cognis.com); Hercules (Wilmington, Del. USA; www.herc.com), now Eastman Chemical; and Westvaco Corporation, Chemical Division (Charleston Heights, S.C. USA; http://www.westvaco.com) are four examples. These companies, and others, also sell Monomer and/or refined iso-oleic acid and/or the hydrogenation products thereof. For example, Arizona Chemical sells their CENTURY® fatty acids, which typically include BCFA. Whether a particular fatty acid contains BCFA or CFA can be readily determined by someone with skill in the art by subjecting a sample of the fatty acid to gas chromatography and/or mass spectrometry, and comparing the resulting chromatogram or mass spectrum to the chromatogram or spectrum of the corresponding pure, i.e., reference material.

Other methods of producing BCFA and CFA may be found in, e.g., “Fatty Acids in Industry” Chapters 7 and 11, edited by R. W. Johnson and E. Fritz, M. Dekker, New York, 1989, ISBN 0824776720.

In one aspect, the BCFA is or includes CH₃—CH[(CH₂)yCH₃]-(CH₂)_{z}—COOH wherein y+z=6-26 and y=0, i.e., the BCFA is an “iso-acid”. In one aspect, the iso-acid contains a total of 6-30 carbons. Iso-oleic and iso-stearic are two preferred iso-acid BCFAs of the present invention. The preferred branching in a BCFA is either a methyl or an ethyl branch.

The FAC may contain some linear fatty acid (non-BCFA and non-CFA), BCFA and/or CFA. If the FAC does contain some BCFA and/or CFA in addition to linear fatty acid that is/are not branched (non-BCFA) or cyclic (non-CFA), then the ratio of non-BCFA:BCFA in the FAC is preferably is at least 60:40 or 70:30 or 80:20 or 90:10 or 95:05 or 98:02 or 99:01 or the BCFA is less than 1 weight percent of the fatty acid in the FAC, and non-CFA:CFA in the FAC is preferably 80:20 or 90:10 or 95:05 or 98:02 or 99:01 or the CFA is less than 1 weight percent of the fatty acid in the FAC

In an additional embodiment, the FAC may contain a major portion of BCFA. For example, in some cases, distillation products of tall oil compositions and/or derivatives thereof may contain high amounts of BCFA as a major portion of the FAC. In some such cases the non-BCFA:BCFA in the FAC may be at most 60:40 or 50:50 or 40:60 or 30:70 or 20:80 or 10:90 or more than 99 weight percent BCFA of the fatty acid in the FAC. Examples of such compositions may be Monomer and isostearic acid. An example of Monomer is that which has been assigned CAS Registry Number 68955-98-6, which is an alternative and distinct product from TOFA. Discussions of the differences between TOFA and Monomer can be found in United States Published Patent Application Numbers 20060009543; 20050075254; 20040242835; 20040210029; 20040176559; and 20040024088, which are all hereby incorporated, in their entirety, herein by reference. One example of such a commercially available FAC having a majority of BCFA of the total fatty acid content is Century MO-6 sold by Arizona Chemical Company. In a preferred aspect of this embodiment, the FAC contains CFA as well.

Derivatives of the fatty acid may be any commonly known derivative of a carbonyl-containing compound known in general Organic Chemistry Textbooks, such as “Organic Chemistry”, 5th Edition, by Leroy G. Wade, which is hereby incorporated, in its entirety, herein by reference. Examples of derivatives of the fatty acid may be an ester thereof or nitrogen-containing derivative thereof such as a nitrile, amide, or amine carboxylate (amide) thereof, as well as those commonly found in black liquor solids, soaps, skimmings, as well as tall oil products such as pitch and/or distillate products thereof.

One aspect of the present invention relates to ester containing derivatives of the fatty acid (fatty acid esters). Such derivatives may contain at least one ester of the fatty acid such as those discussed in WO 2005/028597, which is hereby incorporated, in its entirety, herein by reference. The ester containing fatty acid may be of the formula: R¹—COOR², where R¹ is as discussed above and R² may be a substituted or unsubstituted hydrocarbon containing from 1 to 30 carbon atoms. R² may contain 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, including any and all ranges and subranges therein.

The —COOR² is an ester functional group. The fatty acid derivative may contain, m, ester functional groups, where m may be from 1 to 10, preferably from 1 to 6 ester functional groups, more preferably from 1 to 3 ester functional groups. Even further, the fatty acid derivative may contain only n acid functional groups as discussed above, only m ester functional groups, or a mixture of n acid functional groups as discussed above and m ester functional groups.

In one preferred embodiment, R² is a short chain alkyl group, including but not limited to a methyl, ethyl, propyl, isopropyl, butyl, sec-butyl, iso-butyl, and tert-butyl group; the most preferred being methyl. According to such most preferred example of this embodiment, the resultant ester containing fatty acid would be a fatty acid methyl ester (FAME).

In another preferred embodiment, R² is a hydrocarbon substituted with one or more alcohol groups such as that described for R¹ above, including but not limited to polyols, glycols, etc. Examples include but are not limited to glycerol and ethylene gylcol. According to such an example of this embodiment, the resultant ester containing fatty acid would be a fatty acid glyceryl ester. To create the above mentioned fatty acid esters, the fatty acid discussed above may be, for example, reacted with an R² precursor where the R² may be, but is not limited, to a hydrocarbon substituted with one or more alcohol groups. When this occurs in this non-limiting example, at least one fatty acid having the above R¹—COOH formula may be reacted and covalently bound to an R² precursor where the R² may be, but is not limited, to a hydrocarbon substituted with one or more alcohol groups.

For example, a mono fatty acid ester may be produced if one fatty acid having the above R¹—COOH formula is reacted and covalently bound to an R² precursor where the R² may be, but is not limited, to a hydrocarbon substituted with one or more alcohol groups. Further, a difatty acid ester may be produced if two fatty acids having the above R¹—COOH formula is reacted and covalently bound to one R² precursor where the R² may be, but is not limited, to a hydrocarbon substituted with two or more alcohol groups. Still further, a trifatty acid ester may be produced if three fatty acids having the above R¹—COOH formula is reacted and covalently bound to one R precursor where the R² may be, but is not limited, to a hydrocarbon substituted with three or more alcohol groups. These examples are not meant to be limiting but to exemplify that the number of fatty acids that can covalently react via an ester linkage with the R² precursor can be any number of fatty acids up until all of the alcohol groups of the R² precursor is depleted.

In an additional non-limiting example, a fatty acid may be reacted with glycerol which has three alcohol groups (i.e. the R² precursor). According to the above exemplified embodiment the fatty acid may be reacted with glycerol in a manner to create a fatty acid derivative wherein the fatty acid derivative (only by a non-limiting example), may be a monofatty acid glycerol ester, a difatty acid glycerol ester, and a trifatty acid glycerol ester.

In a preferred aspect of the present invention, the FAC is a distillation product from tall oil, and the FAC includes fatty acids commonly associated with tall oil fatty acids (TOFA). In one aspect, the FAC contains TOFA. Further, the FAC may contain crude tall oil (CTO) and/or distilled tall oil (DTO). Examples of tall oil product sources are those commercially available from Arizona Chemical Company, including commercially available Sylfat products from Arizona Chemical Company, more specifically Sylfat 2, Sylfat 2LT, Sylfat FA1, Sylfat FA2, and Sylfat FA3. Still preferred fatty acid containing compositions may be North American TOFA or distillates thereof, Scandanavian TOFA or distillates thereof, including blends of each. Still further, each of these fatty acid containing compositions may be esterified as discussed above, preferably methyl and/or glyceryl esters thereof.

Since BCFA contains at least one acid functionality similar to the fatty acids discussed above, derivations of the BCFA may exist such as those described for the fatty acid above. Therefore, in another aspect, the BCFA may be a derivative of BCFA, such as for example an ester- or nitrogen-containing derivative of BCFA when present in the FAC. Examples of FAC's containing derivatives of BCFA are, without limitation, Monomer Esters. Examples of such would be esters of Century MO-6. Some exemplified esters may be Monomer glycerol esters, Monomer methyl esters, and Monomer trimethylolpropane (TMP)-esters which are commercially available for example from Arizona Chemical Company as Uniflex product lines such as Uniflex 1803, Uniflex 336, and Uniflex 936.

Thus, in one exemplary embodiment of the present invention, the FAC contains from 10-80% mono-saturated fatty acids, 10-80% poly-unsaturated fatty acids, 0-50% saturated fatty acids, and 0-50% cyclic fatty acids. In another exemplary embodiment of the present invention, the FAC contains 40-60% mono-saturated fatty acids, 40-60% poly-unsaturated fatty acids, less than 5% saturated fatty acids, and less than 10% cyclic fatty acids. In yet another exemplary embodiment of the present invention, the FAC contains 25-35% mono-unsaturated fatty acids, 55-80% poly-unsaturated fatty acids, less than 5% saturated fatty acids, and less than 10% cyclic fatty acids. In these embodiments, a preferred cyclic fatty acid is one, or a mixture of, resin acids.

Fatty acids may be saturated or unsaturated and the FACs of the present invention may contain one or the other or mixtures of both saturated and unsaturated fatty acids.

Saturated fatty acids include, without limitation, valeric acid, caproic acid, enanthic acid, caprylic acid, pelargonic acid, capric acid, lauric acid, myristic acid, palmitic acid, margaric acid, stearic acid, arachidic acid, behenic acid, lignoceric acid, cerotic acid, montanic acid, and melissic acid.

Fatty acids may be mono- or poly-unsaturated fatty acids and the FACs of the present invention may contain one or the other or mixtures of both mono- and poly-unsaturated fatty acids.

For example, unsaturated fatty acids include, without limitation, caproleic acid, palmitoleic acid, oleic acid, vaccenic acid, elaidic acid, brassidic acid, erucic acid, and nervonic acid.

For example, polyunsaturated fatty acids include, without limitation, linoleic acid, pinoleic, linolenic acid, eleostearic acid, and arachidonic acid.

In an embodiment, the FAC contains at least 50 wt %, preferably, at least 60 wt %, more preferably at least 70 wt %, most preferably at least 75 wt % of oleic and/or linoleic acid or derivatives thereof, based upon the total weight of the FAC. The FAC may contain from 50 to 100 wt %, preferably from 60 to 99, more preferably from 65 to 95 wt % of oleic and/or linoleic acid or derivatives thereof based upon the total weight of the FAC. The FAC may contain 50, 55, 60, 65, 70, 75, 77, 80, 82 85, 87, 90, 92, 95, 98 and 100 wt % of oleic and/or linoleic acid or derivatives thereof based upon the total weight of the FAC, including any and all ranges and subranges therein.

In an additional embodiment, when the FAC contains both oleic and linoleic acids or and/or derivatives thereof, the FAC may contain any amount of oleic and linoleic acids or and/or derivatives thereof. It is preferable that the weight ratio of oleic acid and/or derivative thereof to linoliec acid or derivative thereof is from 5:1 to 1:5, preferably from 4:1 to 1:2, more preferably from 3.5:1 to 1:1, based upon the total weight of the oleic acid and/or derivative thereof and the linoliec acid or derivative thereof. The ratio may be 5:1, 4:1, 3.9, 3.7:1, 3.5:1, 3.2:1, 3.0:1, 2.7:1, 2.5:1, 2.2:1, 2.0:1, 1.8:1, 1.5:1, 1.2:1, 1:1, 1:1.5; 1:2; 1:2.5; 1.3; 1:3.5; 1:4, 1:4.5, and 1:5, including any and all ranges and subranges therein.

Suitable FAC are available from many commercial suppliers, e.g., Uniqema (division of ICI; New Castle, Del. USA; www.uniqema.com); Cognis Corp USA (division of Cognis BV; Cincinnati, Ohio USA; www.cognis.com); Akzo Nobel Inc. (Chicago, Ill. USA; www.akzonobelusa.com); Croda International Plc (East Yorkshire, U.K.; www.croda.com); Arizona Chemical (Jacksonville, Fla. USA; www.arizonachemical.com); Georgia Pacific (Atlanta, Ga. USA; www.gp.com); Hercules (Wilmington, Del. USA; www.herc.com) now Eastman Chemical; and Westvaco Corporation, Chemical Division (Charleston Heights, S.C. USA; http://www.westvaco.com).

Addition examples of fatty acids and derivatives thereof, as well as the exemplified FACs, are described in WO1994017160; WO2006002683; and WO2005123890, which are hereby incorporated, in their entirety, herein by reference.

Additional FAC's are those already having considerable low temperature stability, including those described in WO 2004/013259, which is hereby incorporated, in its entirety, herein by reference. The low temperature stability of the FAC may be determined by any of the following four simple laboratory tests, which are exemplary only. These include, for example, long-term storage, cloud point (CP), pour point (PP), and cold filter plugging point (CFPP).

Low temperature stability may be determined by measuring the cloud point of a sample. Determining the cloud point of a sample is a well-known technique, and is described in ASTM D2500/IP219/ISO3015 from American Society for Testing and Materials (West Conshohocken, Pa.; http://www.astm.org). Many vendors sell equipment specifically designed to measure cloud point according to this ASTM procedure. See, e.g., Herzog HCP 852 Pour & Cloud Point Analyzer from Walter Herzog GmbH (Lauda-Königshofen, Germany; a subsidiary of PAC Petroleum Analyzer Company L.P., Pasadena, Tex., USA; www.paclp.com); and CPP97-2A Version 2 Automatic Cloud and Pour Point Analyzer from GT Instruments (a division of Gecil Process; Saint-Cyr-au-Mont-d'Or, France; www.gecil.com). Essentially, the cloud point test cools a sample while monitoring for crystal formation. The cloud point is that temperature at which crystals begin to appear. A lower cloud point denotes better low temperature stability.

Low temperature stability may also be determined by monitoring the appearance of a cooled sample over an extended period of time. Thus, a sample is placed in a container, and the container is placed into a cooled environment. On a periodic basis, for example, daily, weekly, or biweekly, the samples are visually examined for clarity. Clarity may be judged on a scale of 1-10, where 1 is crystal clear and 10 is opaque. While this method does not provide unambiguous quantitative data, the method is quite satisfactory for monitoring the relative low temperature stability of several samples.

Differential scanning calorimetry (DSC) is another technique that may be used to determine low temperature stability. A sample may be subjected to the following heating and cooling regime: heat from 25° C. to 100° C. @ 50° C./min; then hold at 100° C. for 2 min; then cool from 100° C. to −50° C. @ 10° C./min; then hold at −50° C. for 2 min; then heat from −50° C. to 100 C @ 20° C./min. The DSC device is used to measure exotherms and endotherms that occur during this heating and cooling regime. A sample that demonstrates a relatively lower temperature of crystallization will have better low temperature stability according to the present invention.

Other methods that may be used to measure the low temperature stability of a FAC or a mixture of FAC and LTS include, without limitation, the pour point of the material, where a lower pour point is indicative of better low temperature stability. The pour point generally indicates the lowest temperature at which the composition can be pumped. Pour point may be measured by, e.g., ASTM D2500/IP219/ISO3015). Another suitable technique is the Low Temperature Flow Test (LTFT). See, e.g., ASTM D4539 and Canadian General Standards Board CAN/CGSB-3.0-No. 140.1.

The FAC may also be, for example, a fuel or biofuel, such as those described below. Accordingly, the fuel or biofuel may act as the FAC, for example, in one aspect as defined herein.

Although the FAC may contain any amount of sulfur, preferably the FAC contains low amounts of sulfur. Preferably, the FAC contains less than 50 ppm sulfur based upon the total weight of the composition. The compositions may be low sulfur and/or ultra low sulfur compositions such as compositions containing at most 25 ppm, at most 15 ppm, at most 10 ppm, and/or at most 5 ppm sulfur based upon the total weight of the compositions. The sulfur content includes any volatile and/or non-volatile sulfur containing species and/or compounds, including those that are either organic and/or inorganic sulfur containing compounds. The composition may contain not more than 50, 45, 40, 35, 30, 25, 22, 20, 18, 15, 12, 10, 8, 6, 5, 4, 3, 2, 1, 0.1, 0.01, 0.001, 0.0001, and 0.00001 ppm of sulfur, including any and all ranges and subranges therein. In some aspects of the invention, the composition may be sulfur free or essentially sulfur free by containing no and/or trace amounts of sulfur.

The amount of sulfur present in the FAC may be determined by any conventional manner of measuring sulfur content therein. Preferably, the sulfur content may be measured by standard tests, including ASTM D 5453 (using an Antec device) with UV fluorescence and/or ASTM D11822 with X-ray fluorescence.

In one embodiment, the FAC may contain at least one unsaponifiable material. Examples of unsaponifiable materials is found, but not limited to, those described in U.S. Pat. Nos. 6,875,842; 6,846,941; 6,344,573; 6,414,111; 4,519,952; 6,623,554; 6,465,665; 6,462,210; and 6,297,353 which are hereby incorporated, in their entirety, herein by reference. Unsaponifiable material may be any neutral material that is not capable of being saponified, or ester thereof. Examples of unsaponifiable materials is found, but not limited to, those described in U.S. Pat. Nos. 6,875,842; 6,846,941; 6,344,573; 6,414,111; 4,519,952; and 6,623,554 6,465,665; 6,462,210; and 6,297,353, as well as United States Patent Application Publication Numbers 20060052462 and 20060041027 which are hereby incorporated, in their entirety, herein by reference. Further examples include, without being limited, stilbenes and fatty alcohol esters.

The composition may have an acid value. Preferably acid values include those greater than 10, including greater than or equal to 10, 11, 12, 13, 14, 15, 20, 25, 30, 35, 40, 45, 50, 55, 60, 65, 70, 75, 80, 85, 90, 95, 100, 105, 110, 120, 125, 130, 140, 150, 160, 170, 180, 190, and 200, including any and all ranges and subranges therebetween. Preferably, the acid value of the composition is greater than or equal to 120, most preferably greater than or equal to 180.

Preferably, the composition of the present invention is a fuel and/or fuel additive composition and/or package composition containing from 0.1 to 99.999 wt %, more preferably from 85 to 99.999 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the composition; from 0.001 to 99.9 wt %, preferably from 0.001 to 1 wt % of at least one cyclic fatty acid, preferably rosin acid compound, selected from the group consisting of natural resin-based acids obtained from residues of distillation of natural oils, amine carboxylates and ester and nitrile compounds of these acids based upon the total weight of the composition.; and not more than 25 ppm, preferably not more than 15 ppm, of sulfur based upon the total weight of the composition. All ranges and subranges within those amounts disclosed above may be utilized.

The present invention may be used in lieu of, or in addition to, one or more other methods that can be employed to address the problem of unsatisfactory performance of fatty acids for intended end uses such as in the fuel industry. For example, methods of improving the low temperature stability of fatty acids and/or to further reduce the amount/concentration of sulfur in the FAC may be used. While the low temperature stability of the FAC is very good, the fuel industry is concerned about the low temperature stability of fatty acids in general; and, may most often turn to one exemplified solution that is focused on the use of heated FAC storage tanks, and/or the addition of solvent, typically hydrocarbon solvent, to the FAC, in order to address the perceived problem of low temperature stability. The use of addition of solvent also may serve to further dilute or lower the concentration of the sulfur in the FAC. Thus, according to the present invention, a FAC may be placed into a heatable storage tank and heated to a sufficient temperature that the low temperature outside the storage tank, i.e., the ambient temperature, does not detrimentally affect the stability of the FAC within the tank.

The FAC may be required to be stable and/or perform at low temperatures. Low temperature stabilizers (LTSs) may be added to the FAC to further improve the FAC's performance at low temperatures. The LTS may be any component that may be added to a FAC so as to improve its low temperature stability, including freezing and/or cloud point suppressants. Examples of LTS's include, without limitation, glycols. Examples of glycols may be but is not limited to polyethylene glycols (PEG), as well as propylene and/or ethylene glycol. Further examples include, without limitation alcohols such as for example lower alkyl alcohols such as for example isopropyl alcohol. Still further, the LTSs may those mentioned in United States Patent Application having U.S. Ser. No. 11/393,387, filed Mar. 29, 2006, having publication number ______, entitled “COMPOSITIONS CONTAINING FATTY ACIDS AND/OR DERIVATIVES THEREOF AND A LOW TEMPERATURE STABILIZER”, which is hereby incorporated, in its entirety, herein by reference. Still further, examples of the LTS include polyamides. Examples of polyamides include without limitation Ester-Terminated PolyAmides (ETPAs), Tertiary-Amide-Terminated PolyAmides (ATPAs), Ester-Terminated PolyEster-Amides (ETPEAs), Tertiary Amide-Terminated PolyEster-Amides (ATPEA), PolyAlkyleneOxy-terminated PolyAmides (PAOPAs), and PolyEther-PolyAmides (PEPAs). These polyamides, as well as their respective methods of making the same, are described in U.S. Pat. Nos. 5,783,657; 6,268,466; 6,552,160; 6,399,713; and 6,956,099, which is hereby incorporated, in its entirety, herein by reference.

When the FAC contains the optional polyamide as an LTS, the FAC contains from 10 ppm to 80 wt % polyamide based on the total weight of the FAC:polyamide composition, including all ranges and subranges therein, may be added to the FAC. This may include at least 10, 20, 30, 40, 50, 60, 70, 80, 90, 100, 110, 120, 130, 140, 150, 175, 200, 225, 250, 300, 350, 400, 450, 500, 550, 600, 650, 700, 750, 1000, 2000, 3000, 4000, 5000, 6000, 7000, 8000, 9000, and 10000 ppm polyamide, including any and all ranges and subranges therein. Further, this may include at most 80, 75, 70, 65, 60, 65, 60, 55, 50, 49, 48, 47, 46, 45, 44, 43, 42, 41, 40, 35, 30, 25, 20, 15, 10, 9, 8, 7, 6, 5, 4, 3, 2, 1, 0.5, 0.1, 0.05, 0.01, 0.005, and 0.001 wt % polyamide, including any and all ranges and subranges therein.

Preferred polyamides are those polyamides commercially available from Arizona Chemical Company, most preferably Sylvaclear A2612, Sylvagel 5600, Sylvagel 5000, Sylvagel 6000, Sylvagel 4000, Sylvaclear 100, Sylvaclear 100LM, Sylvaclear C75v, Uniclear 100, and Uniclear 100v.

The LTS and FAC may be contacted with each other via mixing, blending, etc. The contacting may occur while applying heat, after applying heat, or before applying heat.

Some solvent may be added to the FAC in order to either further enhance the low temperature stability of the mixture or to achieve a dilution of the sulfur content of the FAC. Suitable solvents for this purpose are well known and currently used in commercial settings. Some of these solvents are: aromatic hydrocarbons, non-aromatic cyclic hydrocarbons; hydrocarbons, branched hydrocarbons, saturated hydrocarbons. Specific solvents known by their chemical names include xylene, heptane, and kerosene. Specific solvents known by their commercial names include SHELLSOL™ heptane and CYCLO SOL™ 100 Aromatic solvent (both from Shell Chemical Company, Houston, Tex. USA; www.shellchemicals.com); SOLVESSO™ 100 and 150, which are but two suitable “Aromatic Fluids” sold by ExxonMobil Chemical (Houston, Tex., USA; www.exxonmobil.com/chemical); and Caromax™ products such as Caromax™ 20 sold by Petrochem Carless. Preferably, the solvent contains a majority of xylene or isomers thereof, most preferably 100 wt % xylene, when it is used according to the present invention.

Still likewise, a cosolvent may be added to the FAC. Examples of the cosolvent include alcohol containing cosolvents, especially when the FAC contain esters of fatty acids and optionally contains an LTS that is preferably a polyamide. The most preferred alcohol containing cosolvents are low molecular weight alcohols, including but not limited to those alcohols having the following formula: R³OH, where R³ a hydrocarbon containing from 1 to 20 carbon atoms. The hydrocarbon may contain 1, 2, 3, 4, 5, 6, 7, 8, 9, 10, 11, 12, 13, 14, 15, 16, 17, 18, 19, and 20 carbon atoms and may be linear or branched. Preferably, the cosolvent is ethanol and/or 2-ethyl hexanol. The cosolvent may be used in addition to or in lieu of the solvent described above.

The optional LTS may be added to the optional solvent or optional cosolvent prior to, after, and/or at the same time as it is contacted with the FAC. Alternatively, the solvent and/or cosolvent may be used alone or individually.

Again the use the LTS, heat, solvent, and/or cosolvent are each individually optionally used with or added to the FAC of the present invention. Any one or more of them, as well as other conventional means for improving the low temperature stability and/or removing (or diluting) the sulfur concentration of the FAC may be used in connection with the FAC of the present invention as well as methods of making and using the same.

The FAC according to the present invention may be used as a fuel additive and/or a fuel blend component, for instance, as a lubricity improver and/or as a fatty acid alkyl ester containing fuel. In an embodiment of the present invention, when the FAC contains a fatty acid alkyl ester, such as for example a fatty acid methyl ester, the FAC may be the fuel, preferably a biofuel. Suitable fuels which may advantageously be combined with the FAC of the invention include, without limitation, middle distillates, diesel, gas oil, gasoline, aviation fuel, biofuel and kerosene. The fuel may also be a low sulphur fuel and/or an ultra low sulfur fuel. The fuel may have a sulfur content, i.e., <500 ppm or <350 ppm or <50 ppm or <25 or <15 ppm or <10 ppm, based upon the total weight of the composition. Further, the fuel may also be sulfur free or essentially sulfur free containing no sulfur and/or trace amounts of sulfur.

The FAC may either be added directly to the fuel, or it may form part of a fuel additive package, where such packages are common in the fuel additive industry. The FAC may include the above-mentioned LTS and/or solvent and/or cosolvent prior to its addition to the fuel and/or fuel additive package. Other components that may be present in the fuel additive package are one or more of detergent, cold flow additive, antifoam, static dissipator, antioxidant, and others additives as used in the art.

In a preferred embodiment, about 20 parts per million (ppm) to 100 wt % of the FAC in the fuel may be necessary, based upon the total weight of the composition. In fact, when the FAC may be used as a fuel itself, the FAC component may take up to 100 wt %, based upon the total weight of the composition. Therefore, in one embodiment, about 20 ppm to 20 wt % of the FAC in the fuel may be necessary, based upon the total weight of the composition. The amount of the FAC may vary and is dependent upon the function of the FAC in the fuel. For example, about 20 to 1000 ppm of the FAC is preferable in instances where the FAC is utilized to afford improved lubricity to the fuel.

In various aspects, the present invention provides a method of improving the performance of a fuel by adding to that fuel a performance-enhancing amount of a FAC, where the mixture has better low temperature stability and/or lubricity than does the fuel alone. In another embodiment, the present invention provides a fuel having both FAC and LTS, where the combination of FAC and LTS is present at a concentration of about 50 ppm to about 20 wt % based on the total weight of the composition. In another aspect, the present invention provides a fuel prepared by the process of combining fuel, FAC and LTS, where these three components are combined in any order, and the FAC and LTS are, in total, present in the fuel at a concentration effective to enhance the performance of the fuel, preferably from 50 ppm to about 20 wt % based on the total weight of the composition.

Again, the LTS is optional and the FAC may be incorporated into the fuel at the above amounts without the LTS.

When the fuel and the FAC used as an additive are present in the composition, the FAC may be present at any amount sufficient to provide any level of desired lubricity to the fuel. In one embodiment where the fuel and FAC are present in a single composition, the FAC is present at an amount that is at least 20 ppm, 30 ppm, 40 ppm, 50 ppm, 60 ppm, 70 ppm, 80 ppm, 90 ppm, 100 ppm, 110 ppm, 120 ppm, 130 ppm, 140 ppm, 150 ppm, 175 ppm, 200 ppm, 225 ppm, 250 ppm, 300 ppm, 400 ppm, and 500 ppm, and present at an amount that is equal to or less than 100, 90, 80, 70, 60, 55, 50, 45, 40, 35, 30, 25, 20, 19, 18, 17, 16, 15, 10, 5, 4, 3, 2, 1, 0.5, 0.1, 0.05, and 0.01 wt % based upon the total weight of the composition, depending upon whether the FAC is used as a fuel additive or whether the FAC is the fuel or a major portion of the fuel. In each of these fuels or methods to prepare a fuel when the LTS is present with the FAC, the weight ratio of LTS to FAC in the fuel may be 1:1; 0.8:1; 0.6:1; 0.4:1; 0.2:1 0.1:1; 0.09:1; 0.08:1; 0.07:1; 0.06:1; 0.05:1; 0.04:1; 0.03:1; 0.02:1; 0.01:1; 0.008:1; 0.006:1; 0.004:1; 0.002:1; 0.001:1; and 0.0001:1 of LTS:FAC.

In one embodiment of the present invention, the FAC composition is a fuel itself, a lubricity improver, friction modifier, a fuel additive package, and/or mixtures thereof. For example, when at least a portion of the FAC is fatty acid alkyl ester, for example a fatty acid methyl ester, the resultant composition may be used directly as a fuel, for example as a biofuel. In another example, when at least a portion of the FAC is for example a monoglycerol TOFA, the FAC may be used directly as a fuel additive. In an additional example, when at least a portion of the FAC is a TOFA-based triglyceride, the composition may be used directly as a fuel. Of course, other fuel additives such as an LTS and/or solvents and/or cosolvents may be a part of the above-mentioned compositions.

The FAC of the present invention may be incorporated into additive packages specifically tailored to the end use and/or function. When such packages are intended to be utilized in fuels, especially diesel fuels, such packages may include solvents, biocides, detergents, corrosive inhibitors, cetane improvers, dyes, and antistatics. Preferably, packages are constructed with low sulfur-containing constituents, including, for example, those described in WO 2005/078052, which is hereby incorporated, in its entirety, herein by reference. Further examples of fuels and additives known to be packaged and utilized in such fuels are summarized and exemplified in the following Table.

TABLE 1
Representative fuels and additives known to be packaged and utilized in such fuels.

| | | | | | Carrier | Combustion | Cetane | Octane | | Smoke |
|---|---|---|---|---|---|---|---|---|---|---|
| | | | Detergents | Dispersant | Fluids | Improver | Improver | Improver | Ethers | Suppressents |
| Major Blend | Spark Ignition | Gasoline, Petrol, | X | X | X | X | | X | X | X |
| Components | | Petroleum Ethers | | | | | | | | |
| | Compression | Diesel, Gas Oils, | X | X | X | X | X | | X | X |
| | Ignition | Middle Distillates | | | | | | | | |
| | Aviation Fuel | Jet Fuel, Kerosene | | | | | | | X | |
| | Heavy Fuel | Heating Oil, Bunker | X | X | | X | | | | X |
| | | Fuel, Marine Fuel, | | | | | | | | |
| | | Asphaltenes | | | | | | | | |
| | Synthetic Fuels | Biomass to Liquid | X | X | X | X | X | X | X | X |
| | | BtL, Gas to Liquids | | | | | | | | |
| | | GtL, Fischer Tropsch | | | | | | | | |
| | | Fuel, | | | | | | | | |
| Minor Blend | Oxygenates | MTBE, ETBE, | X | | X | X | | | | X |
| Components | | TAME, TAEE | | | | | | | | |
| | Bio-fuels | | | | | | | | | |
| | Alcohols | Ethanol, Methanol, | X | X | X | X | | X | X | X |
| | | Butanol, Alkyl c1-8 | | | | | | | | |
| | Esters | FAME, FAEE, | X | X | | X | | | | X |
| | | Triglycerides, | | | | | | | | |
| | | Vegetable Oils | | | | | | | | |
| Special | Gaseous Fuels | LPG, CNG, DME, | | | | | | | | |
| | | Hydrogen | | | | | | | | |

| | | | Particulate | Exhaust | ColdFlow | Wax | | | | |
|---|---|---|---|---|---|---|---|---|---|---|
| | | | Filter | After | Improver | Anti-Settling | | | | |
| | | | Regeneration | Treatment | CP/PP/ | Additive | Viscosity | Icing | Corrosion | Lubricity |
| | | | Additives | Additive | CFPP | WASA | Modifer | Inhibitors | Inhibitors | Improver |
| Major Blend | Spark | Gasoline, Petrol, | | X | | | | | X | |
| Components | Ignition | Petroleum Ethers | | | | | | | | |
| | Compression | Diesel, Gas Oils, | X | X | X | X | | | X | X |
| | Ignition | Middle Distillates | | | | | | | | |
| | Aviation | Jet Fuel, Kerosene | | | | | | X | X | X |
| | Fuel | | | | | | | | | |
| | Heavy Fuel | Heating Oil, Bunker | X | X | X | X | X | | X | |
| | | Fuel, Marine Fuel, | | | | | | | | |
| | | Asphaltenes | | | | | | | | |
| | Synthetic | Biomass to Liquid | X | X | X | X | X | | X | X |
| | Fuels | BtL, Gas to Liquids | | | | | | | | |
| | | GtL, Fischer | | | | | | | | |
| | | Tropsch | | | | | | | | |
| | | Fuel, | | | | | | | | |
| Minor Blend | Oxygenates | MTBE, ETBE, | | | | | | | X | X |
| Components | | TAME, TAEE | | | | | | | | |
| | Bio-fuels | | | | | | | | | |
| | Alcohols | Ethanol, Methanol, | | | X | | | | X | X |
| | | Butanol, Alkyl c1-8 | | | | | | | | |
| | Esters | FAME, FAEE, | X | X | X | X | X | | X | |
| | | Triglycerides, | | | | | | | | |
| | | Vegetable Oils | | | | | | | | |
| Special | Gaseous | LPG, CNG, DME, | | | | | | | | |
| | Fuels | Hydrogen | | | | | | | | |

| | | | Friction | | | | Static | Metal | Thermal | Anti- |
|---|---|---|---|---|---|---|---|---|---|---|
| | | | Modifiers | Dehaze | Demulsifier | Antifoam | Dissipators | Deactivators | Stabiliers | oxidants |
| Major Blend | Spark Ignition | Gasoline, Petrol, | X | X | X | | X | X | | X |
| Components | | Petroleum Ethers | | | | | | | | |
| | Compression | Diesel, Gas Oils, | X | X | X | X | X | X | | X |
| | Ignition | Middle Distillates | | | | | | | | |
| | Aviation Fuel | Jet Fuel, Kerosene | | | X | | X | X | X | X |
| | Heavy Fuel | Heating Oil, Bunker | | X | X | | | X | X | X |
| | | Fuel, Marine Fuel, | | | | | | | | |
| | | Asphaltenes | | | | | | | | |
| | Synthetic Fuels | Biomass to Liquid | X | X | X | X | X | | X | X |
| | | BtL, Gas to Liquids | | | | | | | | |
| | | GtL, Fischer | | | | | | | | |
| | | Tropsch | | | | | | | | |
| | | Fuel, | | | | | | | | |
| Minor Blend | Oxygenates | MTBE, ETBE, | | X | | X | | | | |
| Components | | TAME, TAEE | | | | | | | | |
| | Bio-fuels | | | | | | | | | |
| | Alcohols | Ethanol, Methanol, | X | X | X | X | X | X | X | X |
| | | Butanol, Alkyl c1-8 | | | | | | | | |
| | Esters | FAME, FAEE, | X | X | X | X | X | X | X | X |
| | | Triglycerides, | | | | | | | | |
| | | Vegetable Oils | | | | | | | | |
| Special | Gaseous Fuels | LPG, CNG, DME, | | | | | | | | |
| | | Hydrogen | | | | | | | | |

| | | | | | | | | | | Lead |
|---|---|---|---|---|---|---|---|---|---|---|
| | | | | | | | | | | Replacement |
| | | | Biocides | Dyes | Markers | Reodourants | Compatibilisers | Surfactants | Solvent | Additives |
| Major Blend | Spark Ignition | Gasoline, Petrol, | X | X | X | X | | X | | X |
| Components | | Petroleum Ethers | | | | | | | | |
| | Compression | Diesel, Gas Oils, | X | X | X | X | | X | | |
| | Ignition | Middle Distillates | | | | | | | | |
| | Aviation Fuel | Jet Fuel, Kerosene | | | | | | | | |
| | Heavy Fuel | Heating Oil, Bunker | X | | X | | X | X | | |
| | | Fuel, Marine Fuel, | | | | | | | | |
| | | Asphaltenes | | | | | | | | |
| | Synthetic Fuels | Biomass to Liquid | X | X | X | X | X | X | | X |
| | | BtL, Gas to Liquids | | | | | | | | |
| | | GtL, Fischer | | | | | | | | |
| | | Tropsch | | | | | | | | |
| | | Fuel, | | | | | | | | |
| Minor Blend | Oxygenates | MTBE, ETBE, | | | | | X | | | |
| Components | | TAME, TAEE | | | | | | | | |
| | Bio-fuels | | | | | | | | | |
| | Alcohols | Ethanol, Methanol, | X | X | X | X | X | X | | X |
| | | Butanol, Alkyl c1-8 | | | | | | | | |
| | Esters | FAME, FAEE, | X | X | X | X | X | X | | |
| | | Triglycerides, | | | | | | | | |
| | | Vegetable Oils | | | | | | | | |
| Special | Gaseous Fuels | LPG, CNG, DME, | | | | | | | | |
| | | Hydrogen | | | | | | | | |

Fuels and fuel additives and fuel additive packages may also be the composition and/or contain the composition of the present invention. Examples can be found in WO01/38461 and/or in GB 2121807 which are hereby incorporated, in their entirety, herein by reference.

The composition of the present invention may be made from a starting composition containing greater than 50 ppm sulfur, preferably greater than 40 ppm, more preferably greater than 30 ppm, most preferably greater than 20 ppm and containing the above-mentioned components of the FAC based upon the total weight of the starting composition. The starting composition may contain from greater than or equal to 500 to 20 ppm of sulfur, preferably from 250 to 20 ppm sulfur, more preferably from 100 to 20 ppm sulfur, based upon the total weight of the composition. The starting composition may contain 500, 400, 300, 200, 100, 90, 80, 70, 60, 55, 50, 45, 40, 35, 30, 25, and 20 ppm of sulfur based upon the total weight of the composition, including any and all ranges and subranges therein. Examples of the starting material may be any tall oil product such as tall oil fatty acids such as for Example those provided by Arizona Chemical Company such as Sylfat SL2, Sylfat FA1, Sylfat FA2, Sylfat FA3.

The composition of the present invention may be made by distilling the starting composition. The distillation step may be conducted using any distillation means. Examples of such distillation means include a short-path distillation column, a wiped film evaporator, a continuous column, a continuous fractionation column, or combinations thereof.

In one embodiment, the starting material is continuously distilled at any temperature and pressure conventionally known in the art.

Alternatively, the present invention may be made contacting and/or stirring the above-mentioned starting composition with an adsorbent, preferably stirred and/or contacted in a regeneratable column. While the adsorbent may be any material having adsorbing means, the adsorbent may be clay, acid-activated clay, silica, activated carbon containing compound, diatomaceous earth, or combinations and/or mixtures thereof. Preferably the adsorbent is a clay, more preferably an acid-activated clay.

Examples of a silica include any commercially available silica, such as those from Ineos, such as for example GASIL IJ623. Examples of the clay include any commercially available clay. Further clays include acid-activated clays such as for example acid activated bentonite and/or montmorillonite such as those from Englehard such as F1 and F20 and/or Sud-Chemie such as Tonsil Supreme 110 FF.

If a clay is used as an adsorbent, the particle size distribution may be any particle size distribution so long as it is capable of producing the low sulfur containing composition of the present invention. For example, the particle size may be such that less than 15%, preferably less than 12%, more preferably less than 10% of the particles have a size that is greater than 150 microns. In a further embodiment, the particle size may be such that less than 25%, preferably less than 22%, more preferably less than 20% of the particles have a size that is greater than 100 microns. In a further embodiment, the particle size may be such that less than 35%, preferably less than 32%, more preferably less than 30% of the particles have a size that is greater than 63 microns. In a further embodiment, the particle size may be such that less than 65%, preferably less than 62%, more preferably less than 60% of the particles have a size that is greater than 45 microns. In a further embodiment, the particle size may be such that less than 35%, preferably less than 32%, more preferably less than 30% of the particles have a size that is greater than 25 microns. This is especially true when the adsorbent is a clay or acid-modified clay.

While the clay may be of any distribution, including the exemplified embodiments mentioned above, a preferred embodiment of a clay to be used as an adsorbent in the adsorbing step, yet is not intended to be limiting, has a particle size distribution such that, clay about 8% of the particles have a size that is greater than 150 microns, about 18% greater than 100 microns, about 28% greater than 63 microns, about 38% greater than 45 microns, and about 58% is greater than 25 microns.

While any amount of adsorbent may be used at the adsorbing step the amount of absorbent used may be greater than 0.001%, preferably greater than 0.01%, more preferably greater than 0.1%, most preferably greater than or equal to 1% of adsorbent based upon the total weight of the composition being subjected to the adsorbing step. Further, the amount of absorbent used may be less than 50, preferably less than 40, more preferably less than 20, most preferably less than 10 wt % of adsorbent based upon the total weight of the composition being subjected to the adsorbing step. The amount of the adsorbent may be 0.001, 0.01, 0.1, 1, 2, 3, 4, 5, 6, 7, 8, 9, 10, 15, 20, 25, 30, 40 and 50% of adsorbent based upon the total weight of the composition being subjected to the adsorbing step, including any and all ranges and subranges therein.

While the adsorbing step may use any adsorbent, the adsorbent may have an average pore size of from 10 to 250, preferably from 20 to 150, more preferably from 40 to 100, most preferably from 50 to 75 angstroms. The pore size of the adsorbent may be 10, 20, 30, 40, 45, 50, 55, 60, 65, 70, 75, 80, 90, 100, 125, 150, 175, 200, 225, and 250 angstroms, including any and all ranges and subranges therein. This is especially true when the adsorbent is a silica and mixtures of silicas having pore size of from 60 to 100 angstroms is preferred.

The adsorbing step and the distilling step may be used in isolation or in combination with one another. Preferably the adsorbing step is conducted to produce the composition of the present invention. However, if the distilling step and the adsorbing step are used in combination, preferably they are used serially to produce the composition of the present invention. While the distilling step may be conducted before or after the adsorbing step, it is preferable that the distilling step occur prior to the adsorbing step.

In one embodiment, the starting material is continuously distilled prior to the adsorbing. In this embodiment, any “cut”, or portion of the distilled starting material, and/or combination of cuts from the column may be removed and distilled. Typically, there may be three portions to the distilling apparatus: a top cut, a bottom cut, and a body or heart or middle cut. In an exemplified embodiment, a 75% heart cut may be removed from the distillation apparatus and subjected to adsorbing. While any % heart cut may be removed and subjected to the adsorbing, it is preferable that at least a 40% heart cut is removed. A material that is subjected to the adsorbing may be any cut, but preferably may be a cut containing from 40 to 95% heart cut, more preferably from 50 to 90% heart cut. The cut may be a 40, 45, 50, 55, 60, 65, 70, 75, 80, 85, 90, and 95% heart cut.

When a “heart” cut is taken from the distilling apparatus, at least a portion of the top cut and/or at least a portion of the bottom cut is removed and discarded therefrom (i.e. not subjected to the adsorbing). In an additional embodiment, the portion that is removed may be from 0 to 50% of the top cut. Therefore, the cut that is subjected to the adsorbing may be one created by removing 0, 5, 10, 15, 20, 25, 30, 35, 40, 45, and 50% of the top cut, including any and all ranges and subranges therein.

In another embodiment, the portion that is removed may be from 0 to 50% of the bottom cut. Therefore, the cut that is subjected to the adsorbing may be one created by removing 0, 5, 10, 15, 20, 25, 30, 35, 40, 45, and 50% of the bottom cut, including any and all ranges and subranges therein.

In another embodiment, the heart cut that is subjected to the adsorbing may be created by removing combinations of the top cut and the bottom cut. Any of the above portions of top cut and bottom cut may be combined, so long as the total % removed of the top and bottom cuts does not add up to more than 40%. However, this is due predominantly to economics and the present invention may also be achieved by removing the top and/or bottom cuts so as that they total an amount equal to more that 40%. In an example not intended to be limiting, a 75% heart cut may be taken from the distillation apparatus and subjected to the adsorbing by removing therefrom about 5% of the bottom cut and 20% of the top cut. In this embodiment when both a portion of the top cut and a portion of the bottom cut are removed, the ratio of the portions of the top and bottom cuts removed from the heart cut prior to subjecting the heart cut to the adsorbing may be from 1:50 to 50:1, preferably 1:25 to 25:1, more preferably, from 1:15 to 15:1, most preferably from 1:10 to 10:1. This range includes 1:50, 1:40, 1:30, 1:20, 1:10, 1:9; 1:8, 1:7, 1:6, 1:5, 1:4, 1:3, 1:2, 1:1, 2:1, 3:1,4:1, 5:1, 6:1, 7:1, 8:1, 9:1, 10:1, 20:1, 30:1, 40:1, and 50:1, including any and all ranges and subranges therein.

Most preferably, the components that make up the starting material are very similar to the components of the FAC of the present invention except that the level of sulfur in the starting composition is greater. These components, their identities and their relative amounts of fatty acids within the starting material are not materially changed and/or are minimally adjusted as the sulfur content is extracted therefrom via contacting the starting material with the adsorbent above. Most preferably, no change occurs at all or less than 5% of that wt % in the starting material for each component: hydrocarbon, rosin acid, and/or unsaponifiable.

The composition of the present invention, when containing low sulfur, may further be utilized as a starting composition for esterification and/or hydrogenation so as to obtain fatty alcohols low in sulfur. Such alcohols may be used in cosmetics, neutraceuticals, fuels, pharmaceuticals, etc. This includes dimers and trimers thereof, as well as methyl and/or ethyl esters thereof.

The sulfur content may be measured by standard tests, including ASTM D 5453 (Antec device) with UV fluorescence and/or ASTM D1822.

The present invention is explained in more detail with the aid of the following embodiment examples.

### EXAMPLES

The impact of distillation and adsorbing steps on the sulfur content of a commercially standard TOFA (i.e. Sylfat 2LT from Arizona Chemical Company) was determined by the following experiment.

The TOFA was optionally distilled in a continuous distillation column at about 190° C. under 2 mm Hg of pressure. When distilled, a 75% heart cut was then subjected to the below described adsorbing treatment. About 5% of the bottom cut was removed and about 20% of the top cut was removed to create the 75% heart cut was then subjected to the below described adsorbing treatment.

Varying amounts (i.e. 0, 1, 2, 3, 4, and 5% based upon the total weight of the heart cut) of the adsorbent, i.e. Tonsil Supreme 110 FF from Sud-Chemie as the clay or GASIL IJ623 from Ineos as the silica) was contacted with the fatty acid (either distilled as mentioned above or undistilled) for 10 minutes, removed by filtration filter to produce the inventive material.

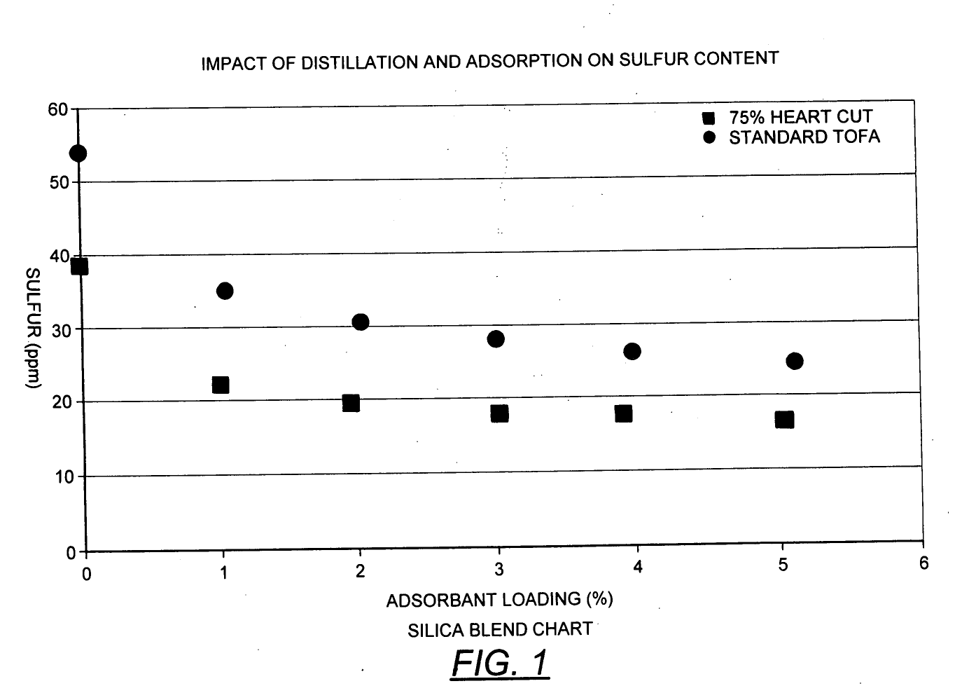

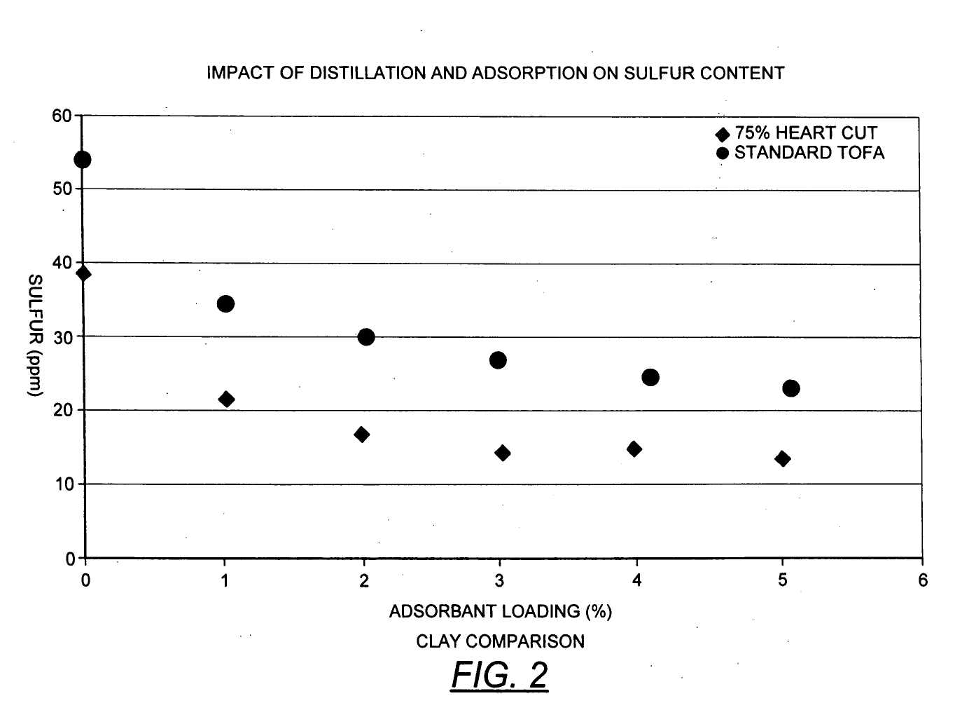

The sulfur content for each of the above was measured using standard tests, in this case ASTM D 5453 (Antec device) with UV fluorescence. The resultant sulfur content of the distilled or undistilled TOFA after being subjected to different amounts of adsorbent (silica or clay) are reported in FIGS. 1 and 2. FIG. 1 shows the results when distilled or undistilled TOFA is subjected to various amounts (1-5%) silica adsorbent, while FIG. 2 shows the results when distilled or undistilled TOFA is subjected to various amounts (1-5%) clay adsorbent.

As used throughout, ranges are used as a short hand for describing each and every value that is within the range, including all subranges therein.

Numerous modifications and variations on the present invention are possible in light of the above teachings. It is, therefore, to be understood that within the scope of the accompanying claims, the invention may be practiced otherwise than as specifically described herein.

All of the references, as well as their cited references, cited herein are hereby incorporated by reference with respect to relative portions related to the subject matter of the present invention and all of its embodiments

We claim:

1) A composition comprising:
from 85 to 99.9% by weight of at least one saturated or unsaturated, monocarboxylic aliphatic hydrocarbon having a linear, branched, and/or cyclic chain of from 8 to 24 carbon atoms, a dimer thereof, a trimer thereof, or mixtures thereof;
from 0.1 to 15% by weight of at least one cyclic fatty acid compound selected from the group consisting of natural resin-based acids obtained from residues of distillation of natural oils, amine carboxylates and ester and nitrile compounds of these acids; and
less than or equal to 25 ppm of sulfur.

2) The composition according to claim 1, comprising less than or equal to 20 ppm.

3) The composition according to claim 1, comprising less than or equal to 15 ppm.

4) The composition according to claim 1, wherein the cyclic fatty acid compound is a rosin acid compound.

5) A method of making the composition according to claim 1, comprising contacting and/or stirring a first composition comprising:
from 85 to 99.9% by weight of at least one saturated or unsaturated, monocarboxylic aliphatic hydrocarbon having a linear, branched, and/or cyclic chain of from 8 to 24 carbon atoms, a dimer thereof, a trimer thereof, or mixtures thereof;
from 0.1 to 15% by weight of at least one cyclic fatty acid compound selected from the group consisting of natural resin-based acids obtained from residues of distillation of natural oils, amine carboxylates and ester and nitrile compounds of these acids; and
greater than 25 ppm of sulfur
with an adsorbent.

6) The method according to claim 5, wherein the first composition comprises greater than or equal to 30 ppm of sulfur.

7) The method according to claim 5, wherein the composition comprises greater than or equal to 40 ppm of sulfur.

8) The method according to claim 5, wherein the adsorbent comprises at least one member selected from the group consisting of activated carbon containing compound, silica, alumina, clay, acid-activated clay, and diatomaceous earth.

9) The method according to claim 5, wherein the adsorbent has an average pore size of from 40 to 100 angstroms.

10) The method according to claim 5, wherein the adsorbent has an average pore size of from 50 to 75 angstroms.

11) The method according to claim 5, wherein the adsorbent is at least one adsorbent selected from the group consisting of silica and clay.

12) The method according to claim 5, wherein the adsorbent is at least one acid-activated clay.

13) The method according to claim 5, further comprising distilling the first composition prior to the contacting step.

14) The method according to claim 13, wherein the first composition comprises greater than or equal to 40 ppm of sulfur prior to said distilling step.

15) The method according to claim 13, wherein the composition comprises greater than or equal to 60 ppm of sulfur prior to said distilling step.

16) The method according to claim 13, wherein the distilling is performed by a short-path distillation column.

17) The method according to claim 16, wherein the short-path distillation column is a wiped film evaporator.

18) The method according to claim 13, wherein the distilling is performed by a continuous column, a continuous fractionation distillation column, or a combination thereof.

19) The composition according to claim 1, wherein the composition is a fuel

20) The composition according to claim 1, further comprising a fuel.

21) The composition according to claim 20, wherein the fuel is a biodiesel, diesel, gasoline, ethanol, or mixtures thereof.

22) A method of making a fuel, comprising contacting diesel fuel, gasoline, or mixtures thereof with the composition according to claim 1.

23) The composition according to claim 1, further comprising at least one solvent.

24) The composition according to claim 1, further comprising at least one solvent selected from the group consisting of an aromatic hydrocarbon, non-aromatic cyclic hydrocarbon, hydrocarbons, branched hydrocarbon, saturated hydrocarbon, xylene, heptane, and kerosene.

25) The composition according to claim 1, further comprising at least one cosolvent.

26) The composition according to claim 1, further comprising at least one cosolvent selected from the group consisting of low molecular weight alcohol, ethanol and 2-ethyl hexanol.

27) The composition according to claim 1, further comprising at least one low molecular weight alcohol having the following formula: R³OH, wherein R³ is a linear or branched hydrocarbon having from 1 to 20 carbon atoms.

28) The composition according to claim 1, further comprising at least one low temperature stabilizer.

29) The composition according to claim 28, wherein the at least one low temperature stabilizer is a polyamide.

30) The composition according to claim 1, further comprising at least one polyamide selected from the group consisting of an Ester-Terminated PolyAmides (ETPAs), Tertiary-Amide-Terminated PolyAmides (ATPAs), Ester-Terminated PolyEster-Amides (ETPEAs), Tertiary Amide-Terminated PolyEster-Amides (ATPEA), PolyAlkyleneOxy-terminated PolyAmides (PAOPAs), and PolyEther-PolyAmides (PEPAs)
